(19) United States
(12) Patent Application Publication
(10) Pub. No.: US 2012/0278171 A1
(43) Pub. Date: Nov. 1, 2012

(54) SYSTEM AND METHOD OF PROVIDING INFORMATION BASED ON STREET ADDRESS

(75) Inventors: Xinyu Tang, Cupertino, CA (US); Charles Chapin, San Jose, CA (US); Bryce Stout, Boulder, CO (US); Brian Edmond Brewington, Fort Collins, CO (US); James Anthony Guggemos, Windsor, CO (US); Mark Limber, Boulder, CO (US); Po-Feng Paul Yang, Sunnyvale, CA (US); Mihai Mudure, San Jose, CA (US); Dale Hawkins, Erie, CO (US)

(73) Assignee: GOOGLE INC., Mountain View, CA (US)

(21) Appl. No.: 13/188,896

(22) Filed: Jul. 22, 2011

Related U.S. Application Data
(63) Continuation-in-part of application No. 12/493,532, filed on Jun. 29, 2009.

(51) Int. Cl. G06Q 30/00; G06F 15/16; G06F 17/30; G06F 3/048

(52) U.S. Cl. 705/14.57; 715/738

(57) ABSTRACT

A system and method is provided that, in at least one aspect, associates a search term with a building that occupies more than one street address by selecting the term based on all of the listings located at all of the street addresses occupied by the building.

### CROSS REFERENCE TO RELATED APPLICATIONS

This application is a continuation-in-part of application Ser. No. 12/493,532 filed on Jun. 29, 2009 the entire disclosure of which is incorporated by reference herein.

### BACKGROUND

There are a variety of services related to searching. For example, a user may enter a search term on a web page offered by a service, and the service returns a webpage containing matching results. A variety of techniques may be used to rank the results. For example, if the results are websites, the websites may be ranked based on their popularity. The results may also be selected and ranked based on the prior search history, e.g., a result is more likely to be ranked higher if many prior users selected the same result in response to a similar query.

A user may also enter a street address or latitude/longitude position as a search request. In response, the user will receive a webpage containing the results of the search. The results may include a map of the requested location and all of the businesses known by the system to be located at the address.

In addition to searching for locations, a user may also enter other search terms. For example, a user may search for “pizza” while viewing a map. In response, the service may provide listings that are proximate to the map and fall within the category of pizza restaurants or otherwise match the request such as having the term “pizza” in their company name. Other results may be provided as well, such as web pages and other information. The service may also display responsive advertisements to the user that are limited to particular geographic areas (e.g., particular cities or ranges of latitude/longitude coordinates).

In certain circumstances, the service also stores an association between the search terms entered by a user and the portion of the map being viewed by a first user. Those terms may be used, either alone or in combination with other prior user searches and criteria, to query and display advertisements when subsequent users view a portion of the map that overlaps with the prior portion.

One system, Google Maps, is also capable of displaying street level images of geographic locations. These images, identified in Google Maps as “Street Views”, typically comprise photographs of buildings and other geographic features and allow a user to view a geographic location from a person's perspective as compared to a top-down map perspective. When a street level image is taken, it is typically associated with a location such as the latitude/longitude position of the camera. The street level image may also comprise a 360° panorama, such that the user may view the panorama—and the objects captured therein—from a variety of angles. The service also displays a street address to the user that is intended to approximate the closest street address to the location of the camera when the image was taken.

### BRIEF SUMMARY

In one aspect, a method of selecting information in response to user interaction with an image of a structure is provided. The method may include transmitting an image of a geographic location to a user at a remote computer as well as determining, using a processor, whether a user interacted with a structure represented in an image associated with the geographic location, where the structure is associated with a plurality of street addresses. It may also include selecting, with a processor, a search term associated with the structure, where the search term was associated with the structure by selecting a search term from a set of potential search terms derived from the listings associated with the plurality of street addresses. Such an aspect also includes retrieving, with a processor and based on the search term, information to be provided to the user and transmitting the information to the user.

In another aspect, a system comprises a memory containing instructions executable by a processor and a processor capable of executing the instructions in the memory. The instructions include: providing image identification data, where the image identification data comprises data identifying a portion of an image that is being displayed to a user and where the image comprises an image of a geographic location; receiving and displaying an advertisement, where the advertisement was selected by: determining whether the portion of the image is displaying a structure associated with a plurality of street addresses; selecting a search term associated with the structure, where the search term was associated with the structure by selecting a search term from a set of potential search terms derived from businesses located at the plurality of street addresses and; retrieving, with a processor and based on the search term, the advertisement.

Another aspect of a system includes first and second computers having first and second processor and memories at first and second nodes, respectively. The computers may communicate over a network, and the first memory may contain a program that displays images of buildings on a display in communication with the first computer and a program that transmits building identification that data identifies a building contained in the image. The second memory may contain data representing (a) whether a building occupies more than one street address, (b) the street address location of listings, (c) listing data, (d) search terms such that each building is associated with a building search term, where a building search term is selected based on the listing data of the listings associated with the street addresses occupied by the building, and (e) images of buildings. The second memory further may contain a program that identifies a search term associated with the building identified by the building identification, a program that selects information based on the search term, and a program that provides the information to the first computer via the network.

Still a further aspect relates to a method that includes: determining, with a processor, a keyword for a single structure by iterating through a plurality of street addresses occupied by a single structure and a plurality of listings associated with the plurality of street addresses, where the keyword is selected from data associated with the listings; identifying, with a processor, the keyword associated with a structure in response to receiving data indicating that a user has interacted with the structure; selecting an advertisement by querying, with a processor and with the keyword identified for the structure, a plurality of advertisements where each advertisement in the set is associated with a keyword; and displaying the advertisement to the user.

### BRIEF DESCRIPTION OF THE DRAWINGS

FIG. 1 is a functional diagram of a system in accordance with an aspect of the system and method.

FIG. 2 is a pictorial diagram of the system of FIG. 1.

FIG. 3 is a functional diagram of data in accordance with an aspect of the system and method.

FIG. 4 is a diagram of sample data associated with a street address in accordance with an aspect of the system and method.

FIG. 5 is a screen shot of a search and search results in accordance with an aspect of the system and method.

FIG. 6 is a screen shot of a webpage associated with a search result in accordance with an aspect of the system and method.

FIG. 7 illustrates sample data associated with a listing in accordance with an aspect of the system and method.

FIG. 8 is a diagram of sample data associated with a listing in accordance with an aspect of the system and method.

FIG. 9 is a diagram of sample data associated with a plurality of listings at a street address in accordance with an aspect of the system and method.

FIG. 10 is a diagram of sample data associated with a plurality of street addresses in accordance with an aspect of the system and method.

FIG. 11 is a screen shot of a search in accordance with an aspect of the system and method.

FIG. 12 is a flowchart of the processing of sample data in accordance with an aspect of the system and method.

FIG. 13 is a screen shot in accordance with an aspect of the system and method.

FIG. 14 is a screen shot of a street level image in accordance with an aspect of the system and method.

FIG. 15 is a flowchart in accordance with an aspect of the system and method.

FIG. 16 is a flowchart in accordance with an aspect of the system and method.

FIG. 17 is a flowchart in accordance with an aspect of the system and method.

FIG. 18 is a flowchart in accordance with an aspect of the system and method.

FIG. 19 is a flowchart in accordance with an aspect of the system and method.

FIG. 20 is a flowchart in accordance with an aspect of the system and method.

### DETAILED DESCRIPTION

In one aspect, the system and method infers a user's intent when the user searches for a particular address or other geographic location. In that regard, the system and method may select advertisements in response to a user searching for street addresses.

The advertisements may be selected by searching for advertisements that match search terms associated with the street address. The search terms may become associated with the address by analyzing the businesses located at the street address. The search terms may comprise the titles and categories of the businesses. The search terms may also comprise the most-popular search terms for finding the businesses at the address. Yet further, a single search term may be selected for the entire street address such that the search term is determined to be the most effective search term for the most popular business at the address.

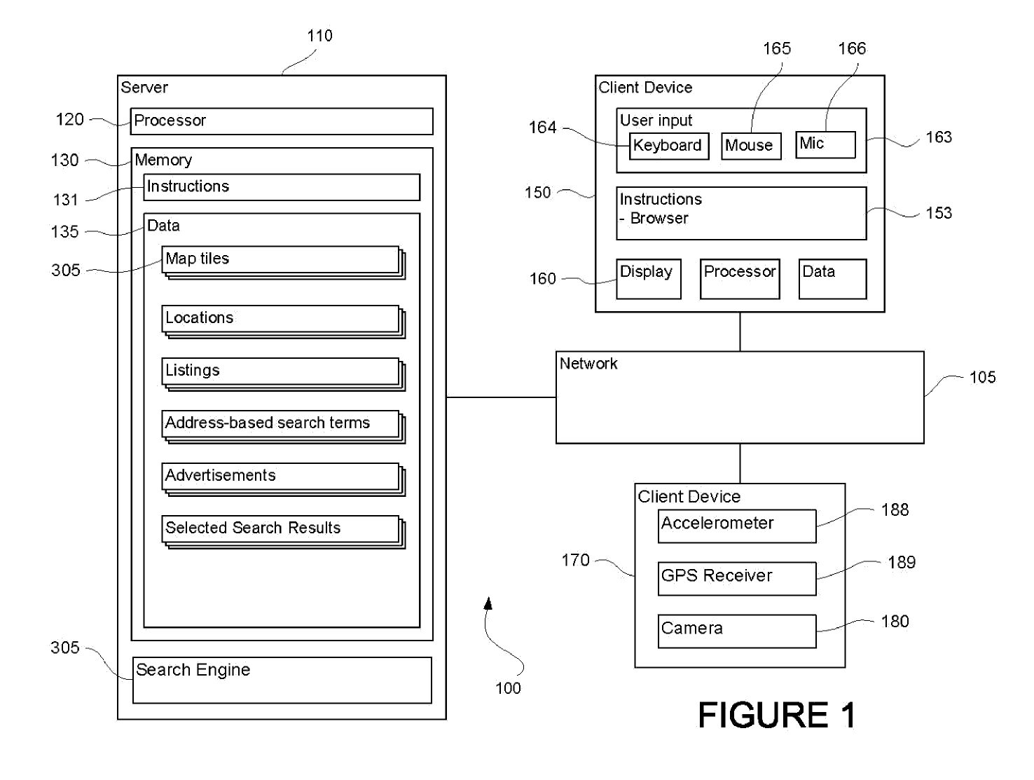

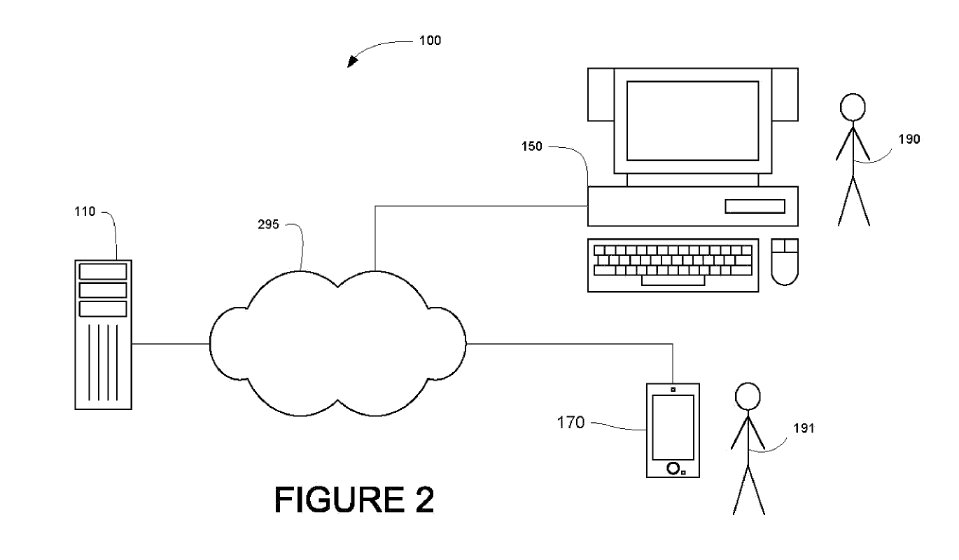

As shown in FIGS. 1-2, a system 100 in accordance with one aspect of the system and method includes a computer 110 containing a processor 120, memory 130 and other components typically present in general purpose computers.

Memory 130 stores information accessible by processor 120, including instructions 131 that may be executed by the processor 120. It also includes data 135 that may be retrieved, manipulated or stored by the processor. The memory may be of any type capable of storing information accessible by the processor, including a computer-readable medium such as a hard-drive, memory card, ROM, RAM, DVD or other optical disks, as well as other write-capable and read-only memories. The processor 120 may be any well-known processor, such as processors from Intel Corporation or AMD. Alternatively, the processor may be a dedicated controller such as an ASIC.

The instructions 131 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

Data 135 may be retrieved, stored or modified by processor 120 in accordance with the instructions 131. For instance, although the system and method is not limited by any particular data structure, the data may be stored in computer registers, in a relational database as a table having a plurality of different fields and records, XML documents or flat files. The data may also be formatted in any computer-readable format such as, but not limited to, binary values, ASCII or Unicode. By further way of example only, image data may be stored as bitmaps comprised of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, pointers, references to data stored in other memories (including other network locations) or information that is used by a function to calculate the relevant data.

Although FIG. 1 functionally illustrates the processor and memory as being within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Accordingly, references to a processor or computer will be understood to include references to a collection of processors or computers that may or may not operate in parallel.

The computer 110 may be at one node of a network 105 and capable of directly and indirectly communicating with other nodes of the network. For example, computer 110 may comprise a web server that is capable of communicating with client devices 150 and 170 via network 105. Yet further, server 110 may use network 105 to transmit and display information to user 190 on monitor 160 of client device 150. Server 110 may also comprise a plurality of computers that exchange information from different nodes of a network for the purpose of receiving, processing and transmitting data to the client devices; is this instance, the client devices may be at different nodes of the network than any of the computers comprising server 110.

Network 105, and intervening nodes between server 110 and client devices, may comprise various configurations and use various protocols including the Internet, World Wide Web, intranets, virtual private networks, wide area networks, local networks, private networks using communication protocols proprietary to one or more companies, cellular and wireless networks, Internet relay chat channels (IRC), instant messaging, simple mail transfer protocols (SMTP), Ethernet, WiFi and HTTP, and various combinations of the foregoing. Although only a few computers are depicted in FIGS. 1-2, it should be appreciated that a typical system can include a large number of connected computers.

Each client device may be configured similarly to the server 110, with a processor, memory and instructions. Each client device 150 and 170 may be a personal computer, intended for use by a person 190-191, having all the internal components normally found in a personal computer such as a central processing unit (CPU), display device 160 (for example, a monitor having a screen, a projector, a touch-screen, a small LCD screen, a television, or another device such as an electrical device that is operable to display information processed by a processor), DVD drive, hard-drive, user input 163 (for example, a mouse 165, keyboard 164, touch-screen or microphone 166), speakers, modem or network interface device (telephone, cable, wireless or otherwise), and all of the components used for connecting these elements to one another.

Although the client devices 150 and 170 may comprise a full-sized personal computer, the system and method may also be used in connection with mobile devices capable of wirelessly exchanging data with a server over a network such as the Internet. For example, a client device 170 may be a wireless-enabled PDA such or an Internet-capable cellular phone. The user may input information using a small keyboard, a keypad (in the case of a typical cell phone), a touch screen (in the case of a PDA) or any other user input device. Indeed, computers in accordance with the systems and methods described herein may comprise any device capable of processing instructions and transmitting data to and from humans and other computers including general purpose computers, network computers lacking local storage capability, and set-top boxes for televisions.

The client devices may also include a component, such as circuits, to determine the geographic location and orientation of the device. For example, client device 170 may include a GPS receiver 189 to determine the device's latitude, longitude and altitude position. The component may also comprise software for determining the position of the device based on other signals received at the client device 170, such as signals received at a cell phone's antenna from one or more cell phone towers if the client device is a cell phone. It may also include an accelerometer 188 or gyroscope to determine the direction in which the device is oriented. By way of example only, the device may determine its pitch, yaw or roll (or changes thereto) relative to the direction of gravity or a plane perpendicular thereto. In that regard, it will be understood that a client device's provision of location and orientation data as set forth herein may be provided automatically to the user, the server, or both.

Although certain advantages are obtained when information is transmitted or received as noted above, other aspects of the system and method are not limited to any particular manner of transmission of information. For example, in some aspects, information may be sent via a medium such as a disk, tape or CD-ROM. In other aspects, the information may be transmitted in a non-electronic format and manually entered into the system. Yet further, although some functions are indicated as taking place on a server and others on a client, various aspects of the system and method may be implemented by a single computer having a single processor.

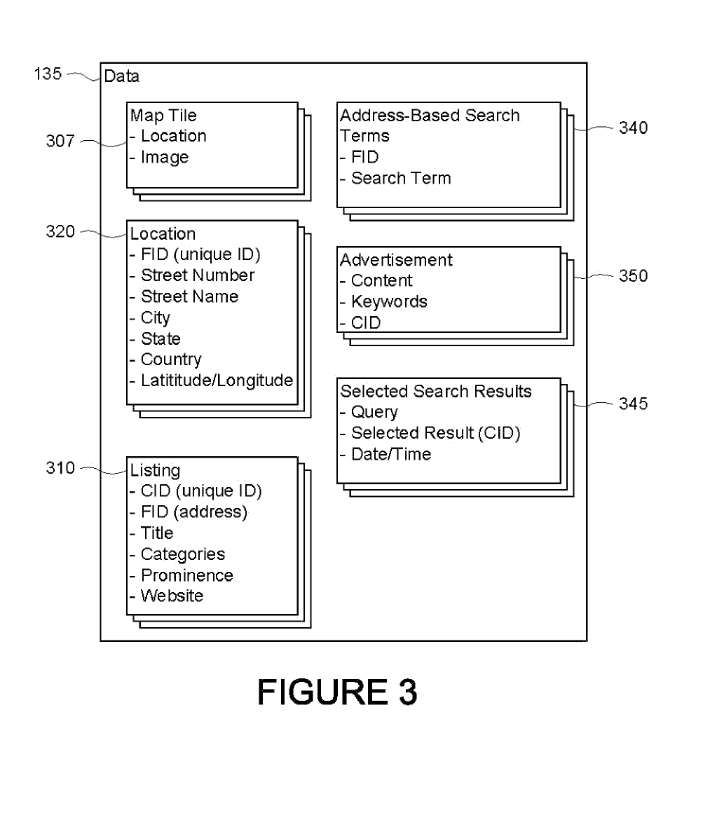

Server 110 may store map-related information, at least a portion of which may be transmitted to a client device. For example and as shown in FIG. 3, the server may store map tiles 307, where each tile is a map image of a particular geographic area. Depending on the resolution (e.g., whether the map is zoomed in or out), one tile may cover an entire region such as a state in relatively little detail. Another tile may cover just a few streets in high detail. The map information is not limited to any particular format. For example, the images may comprise street maps, satellite images, or a combination of these, and may be stored as vectors (particularly with respect to street maps) or bitmaps (particularly with respect to satellite images).

The various map tiles are each associated with geographical locations, such that the server 110 is capable of selecting, retrieving and transmitting one or more tiles in response to receiving a geographical location.

A location may be expressed and requested in various ways including but not limited to latitude/longitude positions, street addresses, street intersections, an x-y coordinate with respect to the edges of a map (such as a pixel position when a user clicks on a map), building names, and other information in other reference systems that is capable of identifying a geographic locations (e.g., lot and block numbers on survey maps). Moreover, a location may define a range of the foregoing.

The system and method may translate locations from one reference system to another. For example, the server 110 may access a geocoder to convert a location identified in accordance with one reference system (e.g., a street address such as “1600 Amphitheatre Parkway, Mountain View, Calif.”) into a location identified in accordance with another reference system (e.g., a latitude/longitude coordinate such as (37.423021°, −122.083939)).

In one aspect and as shown in FIG. 3, data 135 defines a set of locations 320 where each location is associated with a street address and a unique identifier (“FID”). Each location 320 may further be associated with a latitude/longitude coordinate, which may represent the actual latitude/longitude position of the street address or an approximation thereof.

The server may also access listing information identifying local businesses or other objects or features associated with particular geographic locations. For example, each listing 310 may be associated with a title (such as a company's name), a category (such as “pizza”, “Italian restaurant” or “ballpark”) and other information (such as store hours and food on a menu). The information may be compiled by automatically gathering business information such as from websites or telephone directories. The information may also be stored by users; the users may enter or edit the listing information themselves via web pages served by the server 110. Accordingly, the listing information may be obtained from various sources and contain potentially overlapping information, such as one category that is managed by the operator of the server and another category that is obtained from third parties (e.g., yellow pages).

The listing data may also be associated with a geographic location. For example, if the listing refers to a store, the location may identify the store's street address. The listing may refer to a particular location 320 via the location's unique FID identifier.

In many cases, there will be a single listing 310 for each different business. However, it will be understood that the same business may be associated with many different listings, and that a single listing may be associated with many different businesses.

Listings may refer to other geographically-located objects in addition to or instead of businesses. For example, listings may also identify individual's homes, landmarks, roads, bodies of land or water, items located in a store, items that can be moved to different locations etc. Therefore, while many of the examples below refer to business listings, most aspects of the system and method are not limited to any particular type of listing.

The server may also store a set of advertisements 350. The system and method may select an advertisement based at least in part on whether it is returned in response to a query containing search terms. For example, a company may pay the operator of the server each time the content of the advertisement is displayed or selected by a user in response to the user searching for the keyword “pizza.” In that regard, advertisements may be associated with keywords which may be used, along with other criteria, to determine whether the advertisement corresponds with one or more search terms. Search terms are typically text based, but may include other types of data including data representing images and sounds.

In one aspect and as shown in FIG. 1, the advertisements 350 may be directly or indirectly associated with geographic locations. For example, an advertiser may have specifically directed that an advertisement be displayed only when a user is viewing a map or other information associated with a particular geographic area, such as a city or latitude/longitude range. Alternatively, the advertisement may be associated with a listing 310 that is, in turn, associated with a location 320. Other advertisements may not be limited or associated with any particular geographic location.

In addition to the operations illustrated in the aforementioned figures, various operations in accordance with a variety of aspects of the system and method will now be described. It should be understood that the following operations do not have to be performed in the precise order described below. Rather, various steps can be handled in reverse order or simultaneously and steps may be added or omitted.

In one aspect, the method associates search terms with street addresses based on the listings located at the street address. The system and method may create sets of search terms by iterating over and analyzing each listing at a street address, and using a variety of information as a source for search terms.

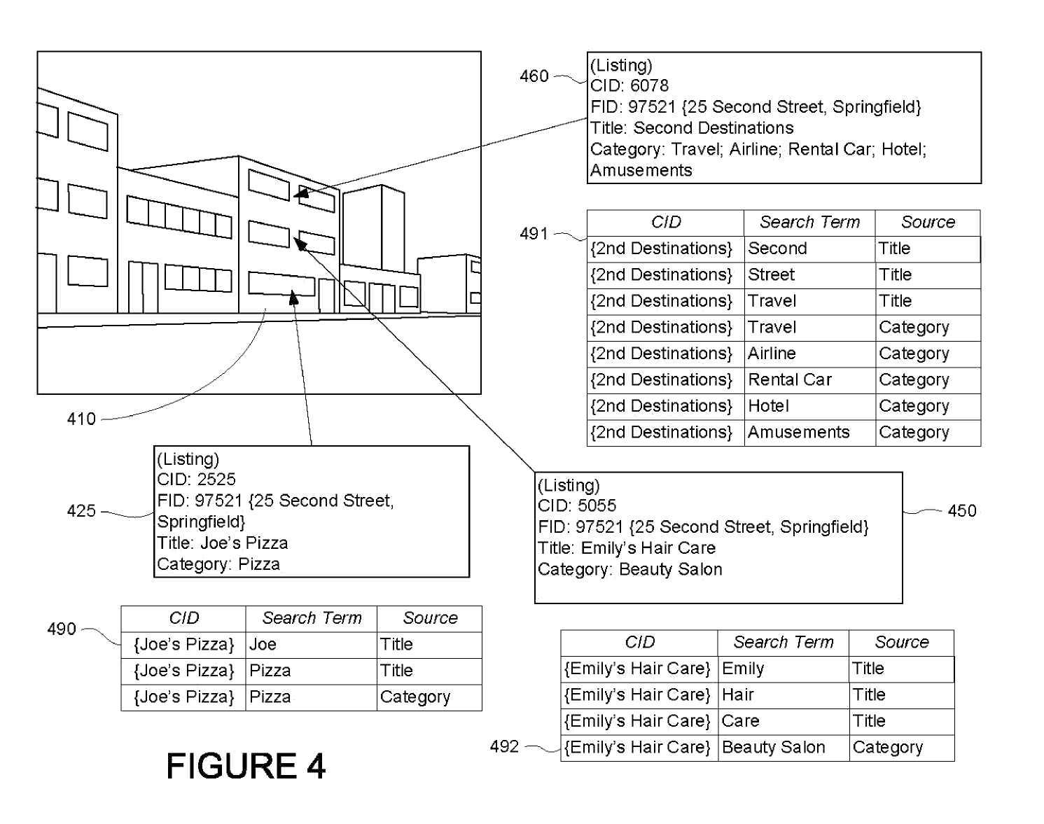

The names and categories of businesses at the address may be used as address-based search terms. For example, as shown in FIG. 4, there may be three different businesses located in a single building 410 at the fictional address “25 Second Street, Springfield”. The first business may be a restaurant on the first floor named “Joe's Pizza” that falls within the category of “pizza.” The business may be represented by listing data 425 and assigned a unique ID (“CID”) 2525. (For ease of reading, various figures use the listing's title in lieu of the numeric CID.) The system and method may thus create a table 490 of search terms based on listing 425, where the search terms are drawn from the words contained in the listing's title and category.

The system and method may similarly iterate through the listings 450 and 460 at the address, and create tables 491 and 492 accordingly.

The system and method may also select search terms from prior searches that were used to find the listing. The search term may come from prior user queries that resulted in the listing being displayed to, and subsequently selected by, the user. Further still, the search term may be selected from the query that resulted in the listing being selected more times than any other query.

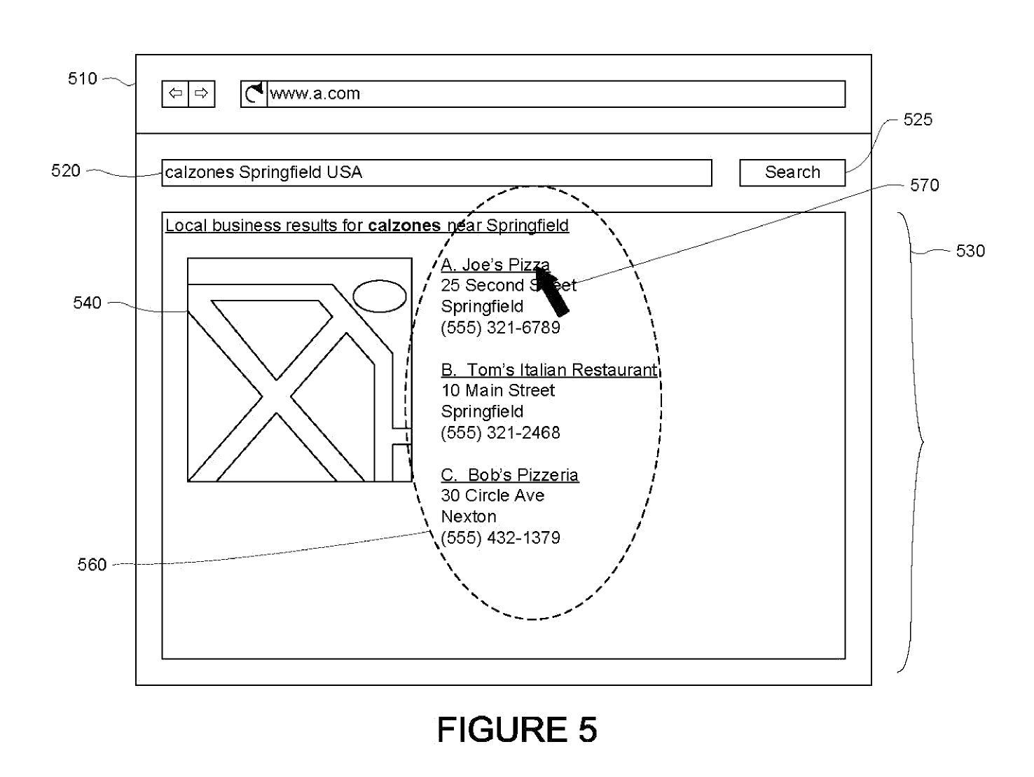

FIG. 5 illustrates a search that may have been conducted by a user. Specifically, the user entered the query “calzones Springfield” into browser 510 (such as a Google Chrome browser) via text box 520. When the user selected the search button 525, the query was transmitted to the server 110 and passed to the search engine 305. The search engine, in turn, interpreted the query as a request to search for listings associated with the term “calzones” in or near the city of Springfield. Server 110 then returned a webpage 530 of search results for display in the browser. The results included a map 540 of the queried geographic location (Springfield) as well as information 560 from listings that match the search. It will be understood that additional and different types of results may have been returned and displayed in the webpage as well, including by way of example only links to web pages, videos, pictures, sponsored links, advertising and other content.

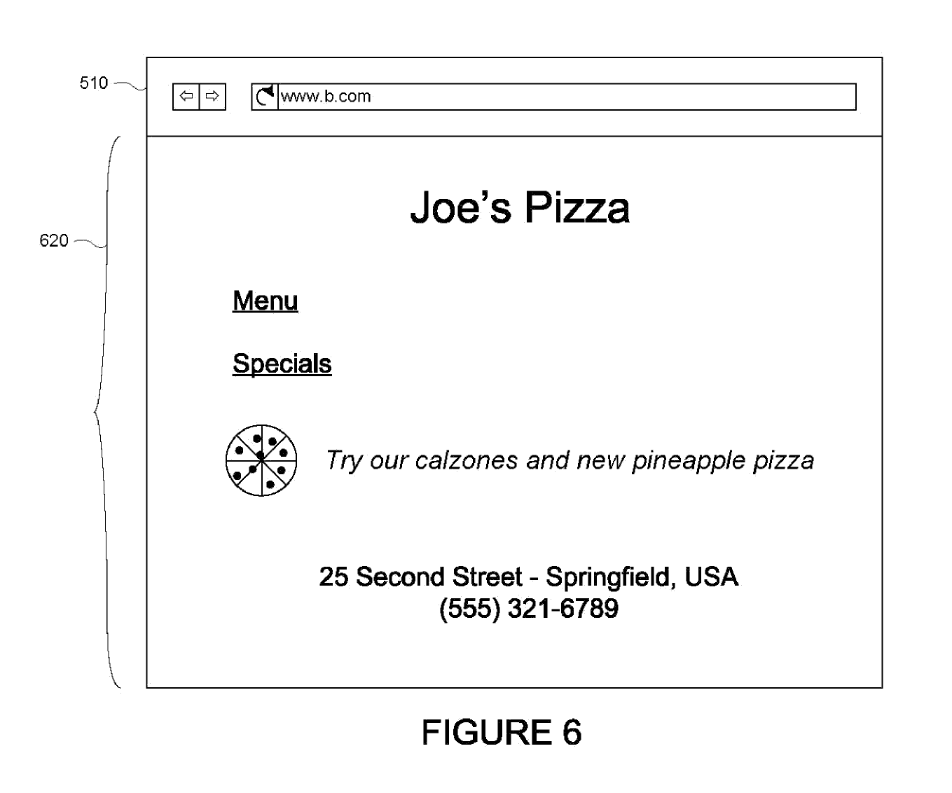

The results of the search may be user selectable. For example, the displayed listing for Joe's Pizza may comprise a hyperlink to the website associated with the business, and the user may use his or her mouse to move cursor 570 to click on the listing. In response and as shown in FIG. 6, the browser 510 may navigate the user to the webpage 620 of the listing. Yet further, the hyperlink may take the user to a webpage served by server by 110 that provides an introduction and summary of the listing. It will be understood that a user may select search result in any number of ways, including using a keyboard to check a checkbox displayed next to the listing.

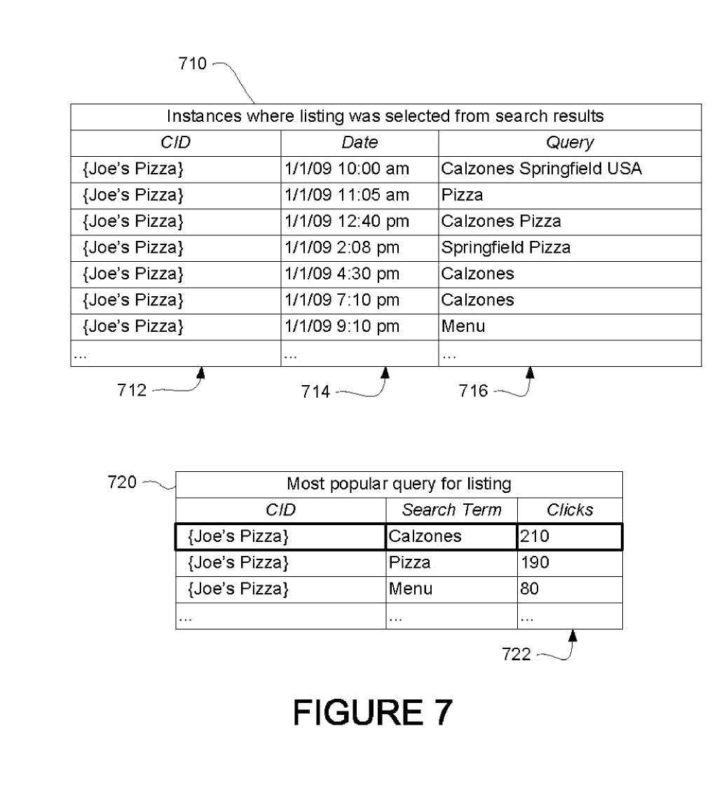

Each time a user selects one of the listings returned as a search result, the system and method may log the selected result and the query that returned the result. For example, as shown in FIG. 7, server 110 may store an entry in a log 710 each time Joe's Pizza was selected by any user in response to a search request. The log identifies the listing 712, the date and time 714 that the listing was selected, and the query 716 that the user entered when the listing was selected.

In one aspect, the system and method may determine whether a geographic location received by a user was a result of a user interaction with an image of a location (e.g., a building, a park, etc.). The user interaction with the image may be, for example, clicking on the image with a mouse, touching the image on a touch screen, or moving a mouse pointer over an image. The user interaction with the image may trigger an event handler in response to the event. The event handler may transmit a flag and a location associated with the image to the server 110. The flag may indicate occurrence of the event to the server 110.

If the system and method determine that a user interaction with an image has occurred, the geographical location associated with the image may be used as a search term. As noted above, the geographical location may be expressed in different ways. For example, if a user clicks on an image of a building, the building's name may be used as a search term.

In one aspect, the most-popular search term is only selected from queries that include a geographic location and another search term (e.g., the location “Springfield” in the query “calzones Springfield”). In other aspects, the most-popular search term is the most-popular search term regardless of surrounding terms in the query.

It will be understood that the log 710 is not limited to any particular data structure. For example, log 710 illustrated in FIG. 7 may comprise a small portion of a variety of data structures 345 (FIG. 3) that store information associating user queries and the results selected by users in response to those queries.

In one aspect, the system and method determines the most popular search term for the listing. For example, as the system iterates through listings, the system and method may query data 345 based on the identity of the listing and obtain a table such as that shown as log 710. The system and method then iterates through the words of the queries, and counts how many queries contain the word and resulted in the listing being selected. The words are then sorted by count as shown in table 720, where the column “clicks” represents how often the term was associated with the selection of the listing (it being understood that a search result may be selected by a user in ways other than clicking it with a mouse). The term associated with the most “clicks” may then be considered the most popular search term for the listing.

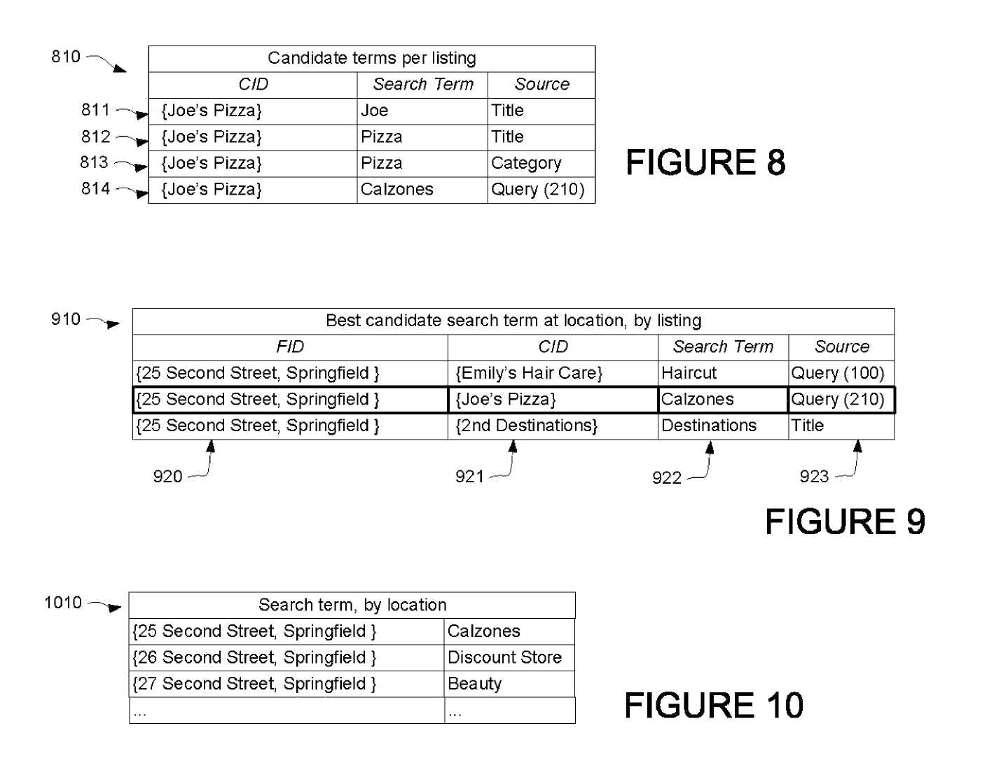

In one aspect of the system and method, the system and method selects a single search term for each listing. FIG. 8 illustrates table 810, which represents all of the candidate search terms for the foregoing example of “Joe's Pizza”.

The system and method may select the most popular search term over other search terms if the most-popular search term is considered sufficiently relevant to the listing.

In certain circumstances, the most-popular search may provide advantages over using a listing's categories. For example, a large department store may be associated with dozens of categories. If a user enters a street address matching the store, it may be difficult to assume that the user was looking for a particular category, e.g., “photos,” “furniture,” or “toys.” However, it may also be discovered that the department store was consistently selected when users queried “discount store.” Accordingly, it may be more reasonable to infer that another user is searching for discount stores when the user enters that address instead of “photos,” “furniture” or similar categories.

Just one method of determining the relevancy of the most popular search term is to determine whether the most successful query for the listing (e.g., “calzones” as shown at reference 811) is associated with a value (e.g., 210 clicks) that exceeds a threshold (e.g., a minimum of 100 clicks).

If the most-popular search term is not sufficiently relevant, the system and method may select one or more of the listing's categories 813. The listing's categories may also be tested for relevancy. For example, a large and prominent department store may be associated with dozens of different categories (e.g., photos, toys and groceries, etc.), none of which are representative of the store. Thus, if the number of categories exceed a threshold (e.g., ten categories), none of the categories may be selected as the listing's search term.

In one aspect, only a single category is selected as the street address. For example, the operator of server 110 may maintain a set of categories and limit each listing to one such category. If the listing is associated with an operator-provided category, the system and method may select the operator-provided category. If the listing is not associated with an operator-provided category but is associated with categories managed by third parties, one of the third-party categories may be selected (e.g., the dominant or first-listed category if there are more than one categories associated with the listing). In yet another aspect, all of the categories associated with a listing may be selected as the search term for the street address.

If the listing's most-popular search term and categories are insufficient, one or more of the search terms 811-12 from the title may be selected. For example, the search term for listing 460 (FIG. 4) may be selected from the listing's title, “Second Destinations” because the large number of categories associated with the listing indicates that the categories are too diverse, which makes it difficult to narrow a search to a particular category.

In one aspect of the system and method, a single search term is selected for an address even if there are multiple listings at the address.

One manner in which the single term may be selected includes selecting the search term for the most popular listing. For example, if two listings each have a web site, and if the first web site is extremely popular with many back links and the second website is relatively rarely visited with relatively few back links, the second website may be considered more popular. In that regard, the listing associated with the second web site may be considered more popular and its search terms would be used for selecting advertisements based on the street address.

In another aspect and as shown in FIG. 9, the system and method may compare the search terms selected from each of the different listings (CID column 921) at the same address (FID column 920). For example, if the most-popular search term for one listing resulted in more selections (e.g., resulted in more “clicks”) than the most-popular search term for another listing, the first search term may be selected for the entire building. Therefore, as shown in table 910, the term “calzones” may be selected for the address because it resulted in “Joe's Pizza” being selected 210 times. This can be compared to the salon's most-popular search term (“haircut”) yielding only 100 selections. It can also be compared to the fact that the travel agency's search term (“destinations”) was taken from the agency's title, which the system and method may deem less likely to yield worthwhile results than prior queries. Other criteria may also be used to select the search term for an address when multiple listings are present.

After the system and method selects a search term for one address, the system and method may select additional search terms for additional addresses. FIG. 10 illustrates a table 1010 of different street geographic locations, each of which is associated with a single search term. As shown in FIG. 3, these search terms 340 may be stored in data 135.

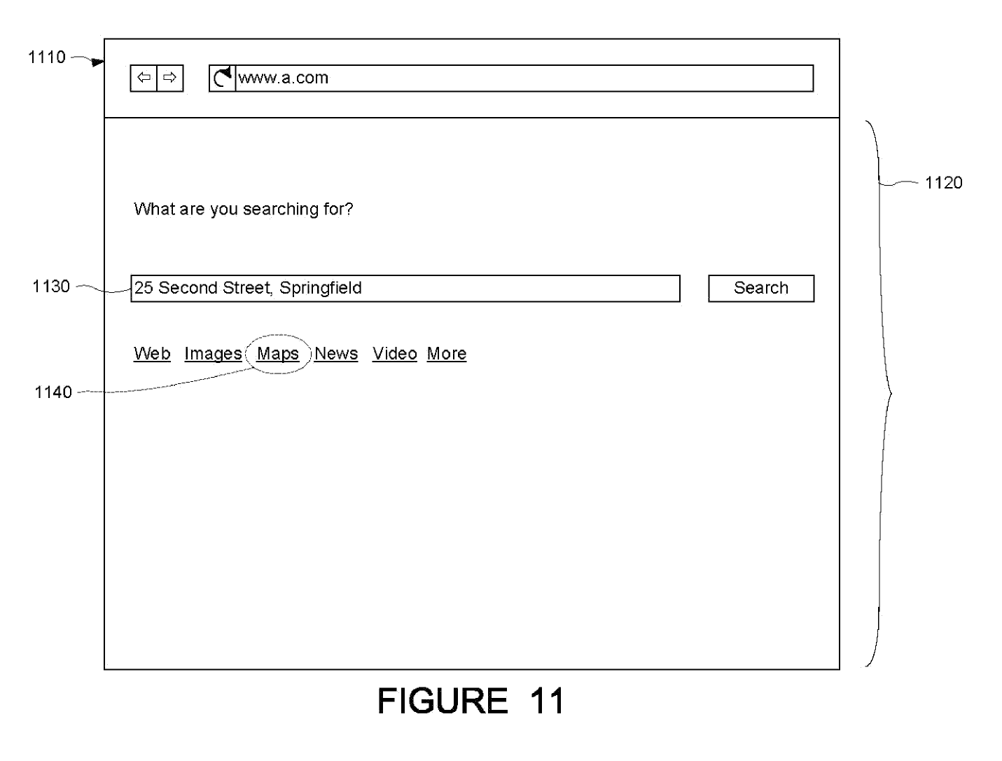

The address-based search terms may be used to select advertisements for display to users. FIG. 11 illustrates a webpage 1120 served by server 110 to client device 150 and displayed on the electronic display using browser 1110. The search page includes a text box 1130 that allows the user of the client device to enter a search request. FIG. 11 provides the example of a user entering the street address “25 Second Street, Springfield” and no other information.

Upon receiving the search query, the search engine 305 may determine that the user is interested in viewing a map of the requested location. This may occur automatically as a result of the user entering an address, or manually as a result of the user's selection of link 1140 entitled “Maps” after entering the query. Regardless, the server 110 may construct a webpage containing a map of the selected address.

The system and method may also select an advertisement based on the address. For example and as shown in FIG. 3, server 110 may query locations 320 for a street address that exactly, or most closely, matches the user's query. When the street address is found, the server 110 uses the location's FID to query the address-based search terms 340 and retrieve a search term.

The address-based search term, in turn, is used to select an advertisement. A number of systems and methods of selecting advertisements based on search terms may be used. However, for purposes of illustration, one aspect may comprise searching advertisements 350 for all advertisements having keywords that correspond with the selected address-based search term. Matching advertisements are then ranked based on any number of criteria, such as ranking an advertisement depending on whether the keyword is an exact match for the address-based search term, the prominence of the business or website associated with the advertisement, and the price of the advertisement.

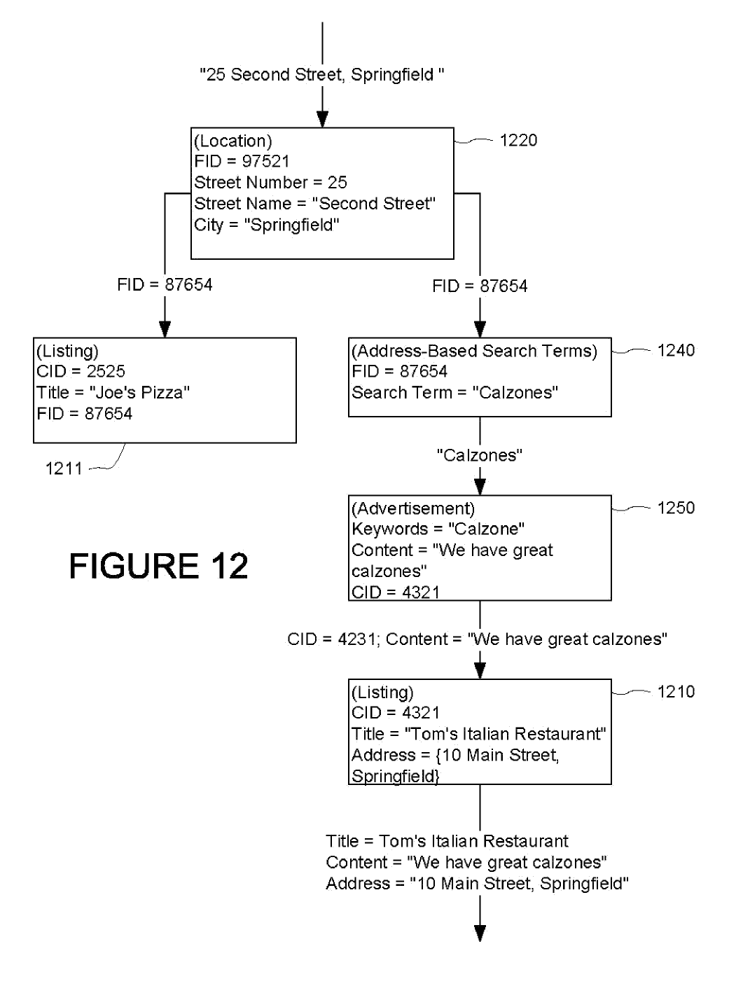

FIG. 12 illustrates how an advertisement may be selected based on the data used in the foregoing examples. The address entered by the user, “25 Second Street, Springfield” is parsed to find a matching location record 1220. The unique identifier (FID=97521) of the matching location is used to retrieve an address-based search term 1240. The search term “calzones” is then used to find an advertisement 1250 that has “calzones” or a variant thereof as a corresponding keyword. If a match is found, the server retrieves the content (“We have great calzones”) and the identification of a listing associated with the advertisement (CID=4321). If there is a listing associated with the advertisement, the identification of the listing may be used to pull additional information about the listing such as its title and address. The server may also retrieve one or more listings 1211 associated with the originally-entered address (e.g., “Joe's Pizza”).

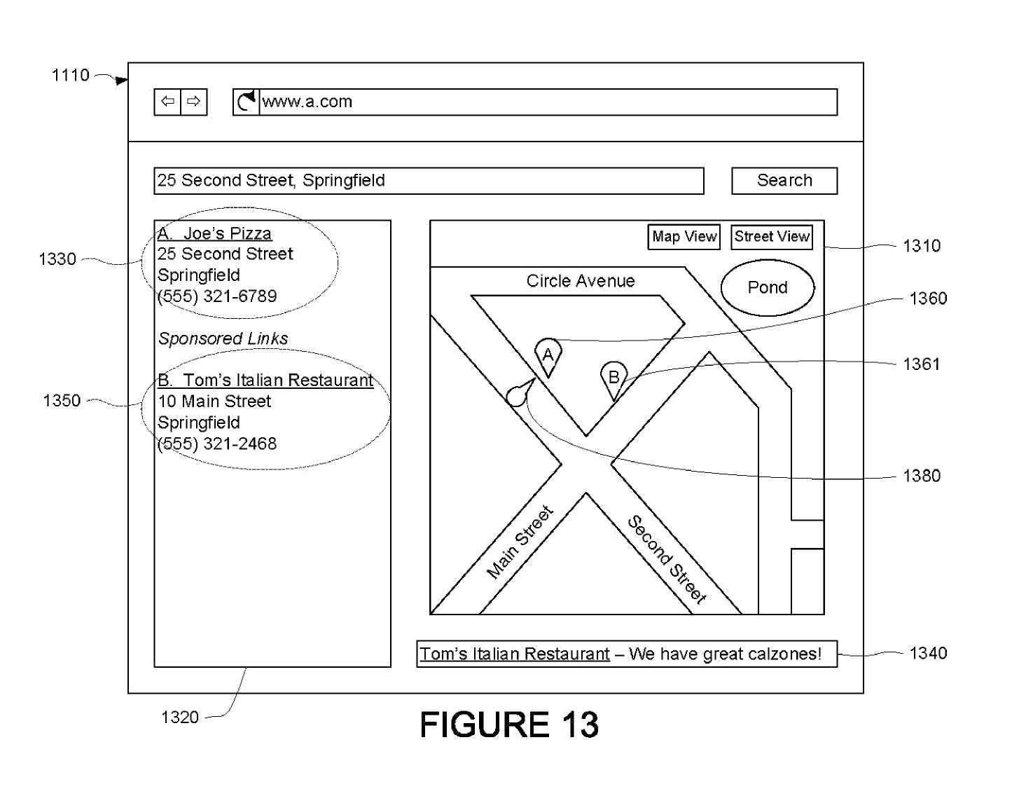

The advertisement selected with the address-based search term may then be displayed to the user that searched for the street address. FIG. 13 illustrates a screen shot that may be displayed to the user that searched for “25 Second Street, Springfield”. The server displays to the user, via browser 1110 on the client device's electronic display, an icon 1380 that identifies the requested address on a map 1310 as well as the text of a listing 1330 at the address (other listings at the address may be displayed as well). The server also displays the advertisement 1340, including in one aspect the name of the advertiser and the content of the advertisement. The server may also display, in the same textbox as the listing at the requested street address, the listing information 1350 of the advertiser as a sponsored link. Icons 1360 and 1361 identifying the location of the listing at the requested address as well as the advertiser, respectively, may also be shown on the map 1310.

In that regard and in one aspect, the system and method may display an advertisement based solely on a street address provided by a user. That advertisement may or may not relate to a business at that address.

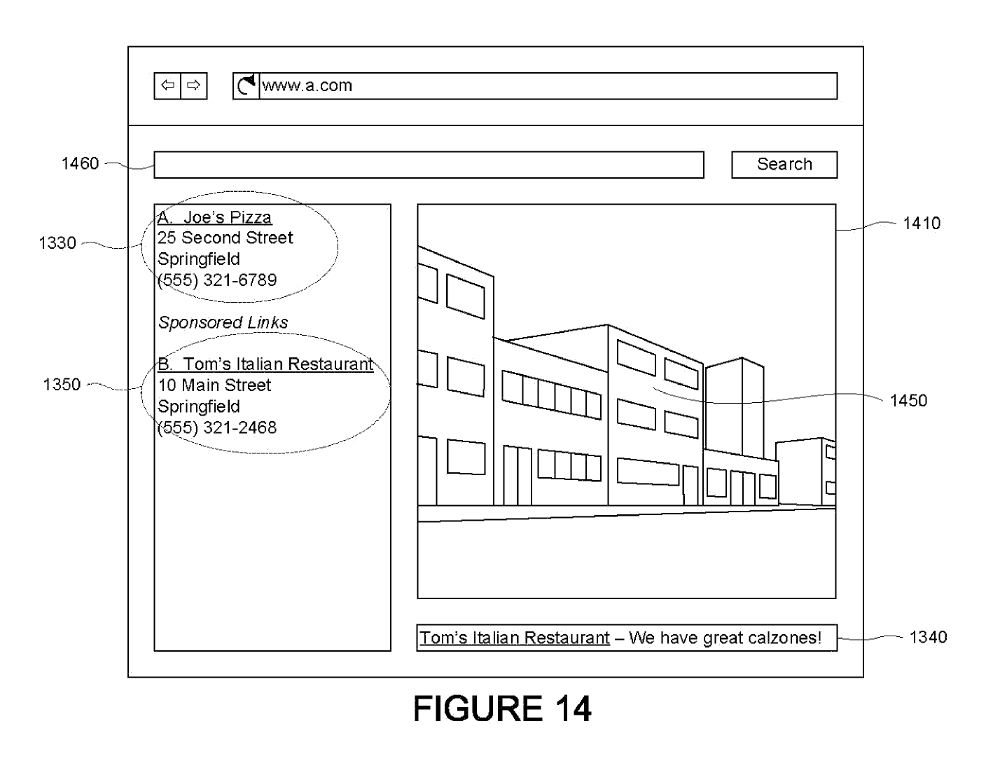

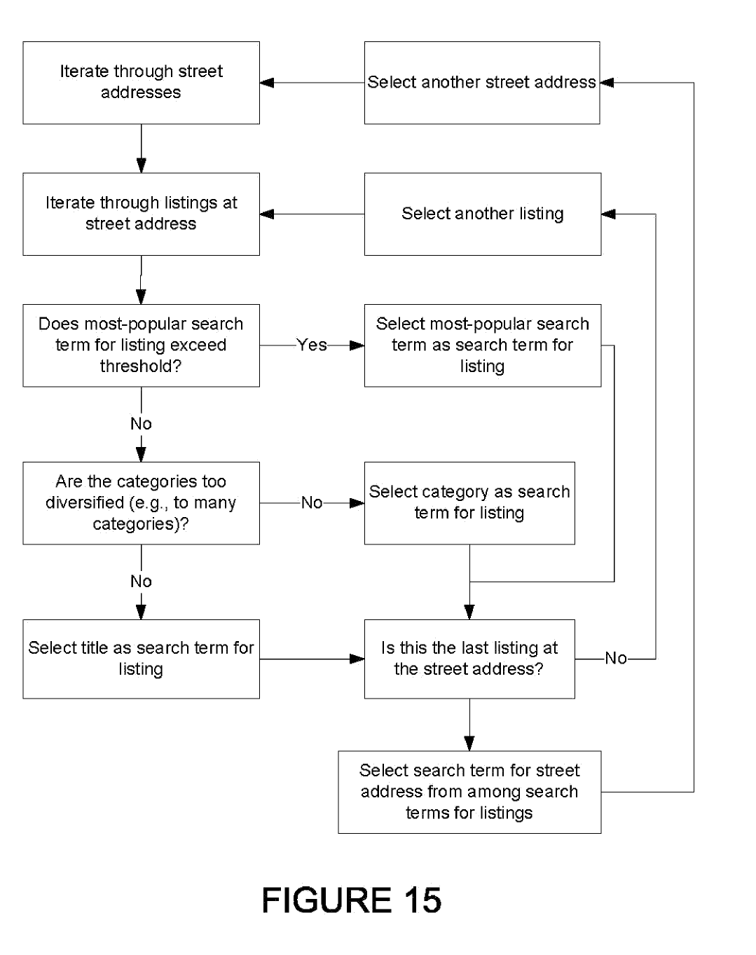

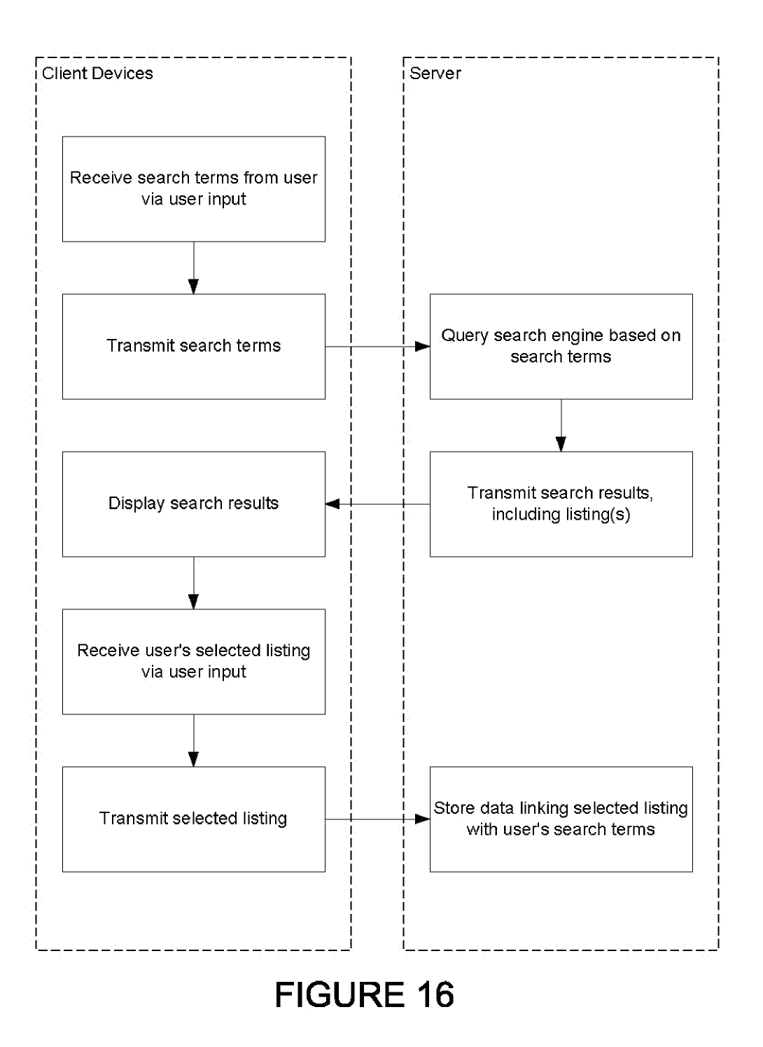

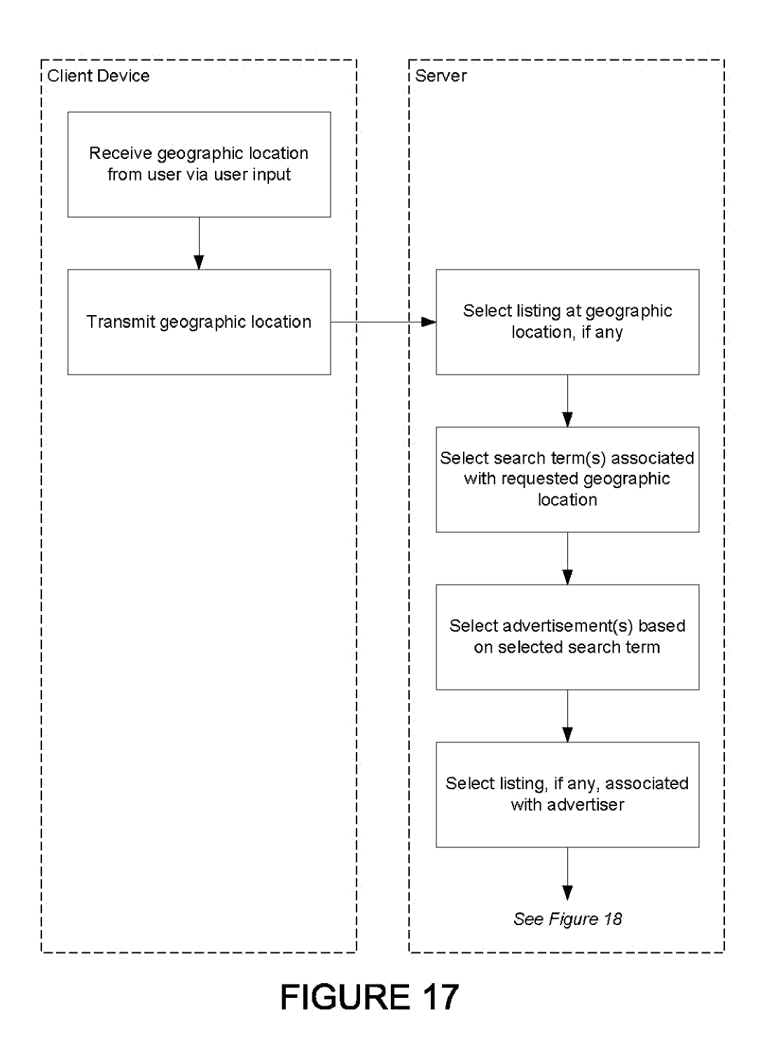

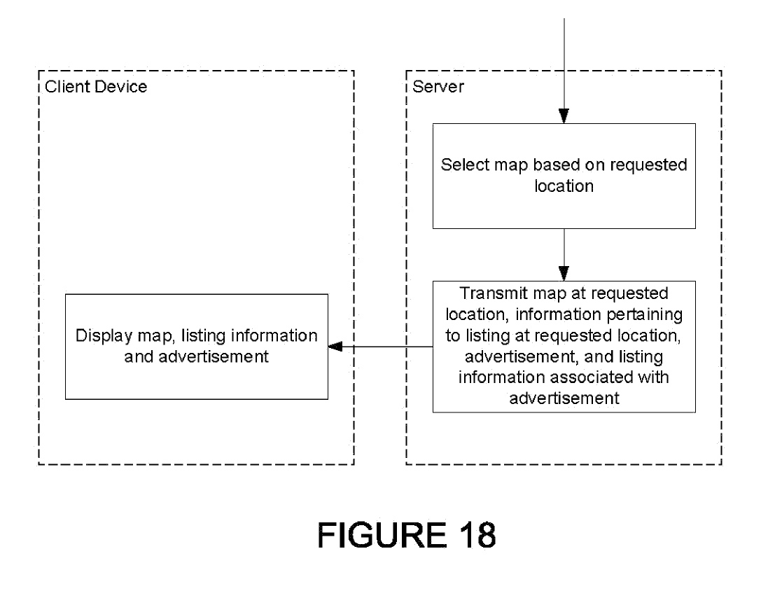

As shown in FIG. 14, the same advertisements 1340 and 1350 may also be shown in connection with a street level image 1410 of the requested location. In one aspect, the user may have entered an address and selected the option of displaying the location in street view.

In another aspect, the user may not have entered a street address but rather navigated to a particular street level image by panning, zooming, etc. In that regard, the user may have navigated to a street level image that displays building 1450 without entering a street address in textbox 1460. If so, the system and method may approximate the street address of the building being viewed based on the latitude/longitude of the street level image and the orientation of the view. The approximated street address may then be used to display advertisements 1340 and 1350.

Accordingly, in at least one aspect, the system and method infers what the user was looking for based on where the user was looking, and selects an advertisement targeted at this inferred intent.

One of the advantages of the invention is its ability to accommodate a wide variety of alternatives.

The system and method may be used in any context where a user enters a street address. For example, in addition to searching for addresses as explained above, the system and method may also be used when a user is searching for directions and enters a destination address.

Moreover, in other aspects, the system and method may also be used to select advertisements for locations expressed in other reference systems. For example, locations expressed in latitude/longitude may also be used to select listings and search terms for advertisements. Just one process for using latitude/longitude comprises storing latitude/longitude in association with a listing and obtaining keywords from listings within range of the requested latitude/longitude location. Yet another process comprises obtaining latitude/longitude from GPS receiver 189 of client device 170, geocoding the latitude/longitude to obtain a street address, and using the street address as described above to obtain an advertisement and display it on the client device.

The system and method may also be used in connection with continuously-changing locations. For example, if the client device 170 is a cell phone, the client device may consistently display new advertisements as the GPS reviver 189 obtains new location information.

The most-popular search term may be determined based on other criteria than the criteria set forth above. For example, the most-popular search term may also be determined based on frequency rather simply the total amount of times the listing was ever selected in response. In that regard, the various queries may be evaluated based on how often they resulted in the listing's selection within the past day, week, month, etc.

The threshold used to determine sufficient relevancy between the query and the listing may comprise more than a fixed numeric value. For example, fifty clicks over the course of a year may indicate sufficient relevancy between a query and a small business such as a local pizzeria. However, fifty clicks may not be sufficient to determine the relevancy between a search term and a listing that is associated with a website that is viewed by hundreds of people a day. In that regard, the threshold may be a function of the listing's prominence. The threshold may also be calculated based on other parameters. Some of these parameters may be specifically tied to the listing under consideration (such as prominence) and others may be independent (such as minimum value of 50 clicks for all listings).

In another aspect of the system and method, each address may be associated with multiple search terms that are used to query advertisements. For example, if there are multiple listings at an address, a search term from each listing (such as both “calzones” and “beauty salon”) may be used to select advertisements. Moreover, rather than selecting only a single search term from each listing, multiple search terms may be selected. For example, all of the search terms shown in table 810 of FIG. 8 or table 910 of FIG. 9 may be used when selecting advertisements for the listing.

When multiple search terms are used to select advertisements, weights may be applied to the terms. For example, the listing's most popular search term may be considered twice as likely as the listing's title to pull an advertisement that will interest a user. Therefore, when the advertisement is queried with both terms, the query may indicate that the most-popular search term should be given twice as much weight when selecting and ranking advertisements for display.

The system and method may also select multiple advertisements based on a single street address. For example, there may be multiple advertisements responsive to the same keyword. In another aspect, different advertisements are selected and displayed based on different search terms from one or many listings. By way of example, a different advertisement may be selected and shown for each search term shown in FIGS. 8 and 9.

The system and method may further assign weights to the location-based search terms and select the number of the advertisements to display based on the weights. The weight may be based on the relative popularity of the most-popular search terms at the requested location. In view of the data shown in FIG. 9, two advertisements may be selected based on “calzones” and one advertisement may be selected based on “haircut” because the listings at the street address received 100 clicks for “haircut” and 210 clicks for “calzones”. Alternatively, the weight may be based on other factors, including information that is neither specific to the requested location nor the location's associated listings. For example, a statistical analysis of all-available evidence may indicate that user's are generally twice as likely to choose advertisements that are selected with the term “haircut” than “calzones.” As a result, the system and method may display twice as many advertisements based on “calzones” than “haircut” in spite of the popularity of the search terms relative to the listings of 25 Second Street. Weights based on combinations of the above are also possible.

As noted above, listings are not limited to businesses. In that regard, the system and method may also be used in connection with points of interest (POI). For example, the street address of the Empire State Building in New York City is “350 5th Ave, New York, N.Y. 10018”. There maybe over one hundred businesses associated with the tenants at that address. In that regard, rather than selecting one of the tenants of the building as the search term for the address, the system and method may use the name of building as the source of the advertisement search term. Thus, one aspect of the system and method may determine whether the street address is associated with a landmark or similar POI listing, and accord more weight to the POI listing than business listings when selecting advertisement search terms.

In yet another aspect, the system and method may determine whether a geographic location received by a user was a result of a user interacting with an image of a structure at a location, such as but not limited to a building. The user interaction with the image may comprise, for example, clicking on an image of a building that is shown in a street level image, touching the name of a building shown in a two-dimensional map that is displayed on a touch screen, or panning a map or street level image such that a particular structure is centered in the display. By way of example, a user may click on the image of building 1450 in street level image 1410. In response to the user interacting with the image of the structure, the system and method may retrieve search terms by retrieving the address of the structure and implementing the methods described above.

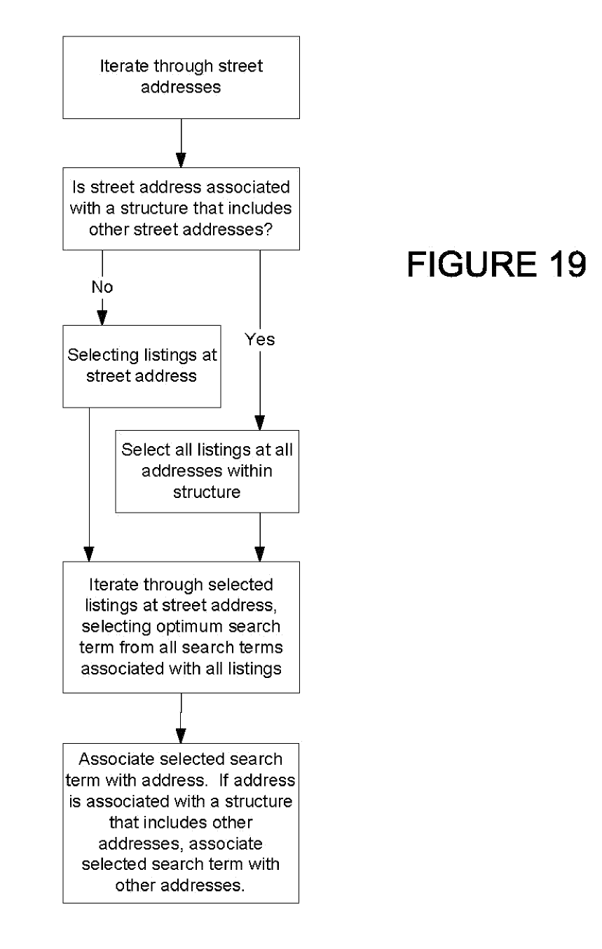

However, a single structure may contain multiple addresses and points of interest. In such an instance, the system and method may be configured to select the best candidate search term for the entire structure based on all of the listings at all of the addresses contained in or otherwise associated with the structure. For example, if building 1450 of FIG. 14 included three street addresses, e.g., 25 Second Street, 26 Second Street and 27 Second Street, then the best candidate search term may be selected from the union of search terms from all of the listings at all three addresses. In this aspect of the system and method, table 910 in FIG. 9 may include search terms from all of the listings at the various addresses contained in the building 1450. As a result, when the street level image 1410 is panned to building 1450, the search term that is used to retrieve advertisement 1350 may be the most popular search term of all three addresses combined. FIG. 19 illustrates various of the foregoing operations and other features of such an aspect.

In still another aspect, when the user enters a specific address, the system and method may use a search term that was retrieved from another address in the same structure. Using the foregoing example, if the most popular search term of all three addresses in building 1450 was “calzones,” then the term “calzones” may be used to request an advertisement when the user enters the street address “26 Second Street” in spite of the fact that the search term “calzones” is associated with a restaurant at 25 Second Street and is not otherwise associated with any listing at 26 Second Street.

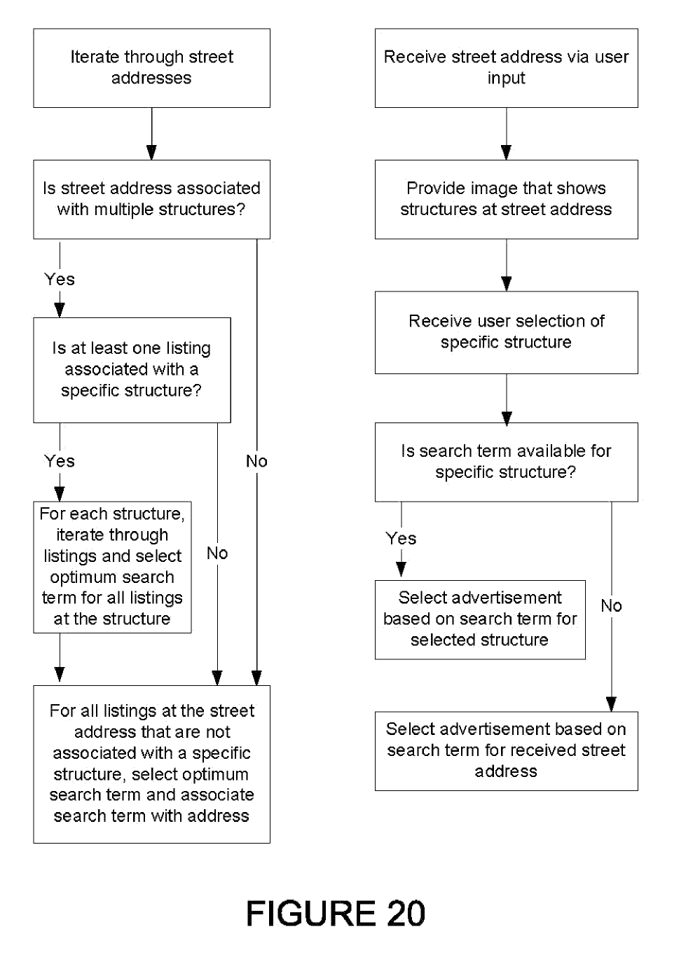

In still another aspect, the search term that is used to retrieve an ad may be selected from one of a plurality of structures at a single address. For example, a street level image or map may display a compound of buildings wherein the entire compound is associated with a single street address. In such an instance, the search terms may be selected from a subset of the listings associated with the address. By way of example, if there are three buildings in an office park at 50 Second Street, then the system and method may determine which of the three buildings is of greatest interest to the user (such as determining, based on the map data, which building is below the mouse pointer when the user clicks on a map that includes the office park). In such an aspect, table 910 of candidate search terms in FIG. 9 may include only the search terms selected from the business in the individual building selected by the user in spite of the fact that there are other listings at the same street address. FIG. 20 illustrates various of the foregoing operations and other features of such an aspect.

In other aspects, functions described above as being performed by the server may be performed by the client device, and vice versa. For example, the server may send listing information at the requested address to the client device, and the client device may use the listing information to determine a search term and request more information. In yet more aspects, the client device and server perform and share different functions.

Instead of advertisements, the system and method may also be used to select descriptions of products, services and other information. For example, if some of the search terms were music related, the system and method may provide a description of local bands, local music venues or location-neutral music information such as song titles.

It will be understood that references herein to “search term” may include search terms that include more than one word, i.e., a search term may comprise multiple words. It will be similarly understood that when a search query “contains” a search term (e.g. “pizza”), the query may only that one term or multiple terms (e.g., “pizza in Springfield”).

Most of the foregoing alternative embodiments are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. It will also be understood that the provision of examples (as well as clauses phrased as “such as,” “including” and the like) should not be interpreted as limiting the claimed subject matter to the specific examples; rather, the examples are intended to illustrate only one of many possible embodiments.

1. A method of selecting information in response to user interaction with an image of a structure comprising:
transmitting an image of a geographic location to a user at a remote computer;
determining, using a processor, whether a user interacted with a structure represented in an image associated with the geographic location, where the structure is associated with a plurality of street addresses;
selecting, with a processor, a search term associated with the structure, where the search term was associated with the structure by selecting a search term from a set of potential search terms derived from the listings associated with the plurality of street addresses;
retrieving, with a processor and based on the search term, information to be provided to the user; and
transmitting the information to the user.

2. The method of claim 1 wherein the structure is a building and the image is street level image of the building.

3. The method of claim 1 wherein the user interaction comprises a user panning an image of the structure on a screen.

4. The method of claim 1 wherein the user interaction comprises clicking on an image of the structure.

5. The method of claim 1 wherein the selected search term is selected from the listing that is expected to be of the most interest to the user.

6. The method of claim 1 wherein the selected search term is the most popular search term associated the plurality of street addresses.

7. The method of claim 1 further comprising receiving a first street address from a user, wherein the search term is selected from a search term derived from a listing at a second street address, and wherein the second street address is associated with the same structure as the first street address.

8. The method of claim 1 further comprising selecting a plurality of search terms associated with the structure, where the selected plurality of search terms are based on a set of potential search terms derived from the listings associated with the plurality of street addresses, and wherein retrieving the information comprises retrieving the information based on selected plurality of search terms.

9. The method of claim 1 wherein the information is an advertisement.

10. The method of claim 1 further comprising displaying the advertisement to the user.

11. A system comprising:
a memory containing instructions executable by a processor;
a processor capable of executing the instructions in the memory;
the instructions comprising:
providing image identification data, where the image identification data comprises data identifying a portion of an image that is being displayed to a user and where the image comprises an image of a geographic location;
receiving and displaying an advertisement, where the advertisement was selected by: determining whether the portion of the image is displaying a structure associated with a plurality of street addresses; selecting a search term associated with the structure, where the search term was associated with the structure by selecting a search term from a set of potential search terms derived from businesses located at the plurality of street addresses and; retrieving, with a processor and based on the search term, the advertisement.

12. The system of claim 11 wherein the advertisement is associated with a link to a webpage and the instructions comprise displaying the advertisement to the user.

13. The system of claim 11 wherein the image displays buildings and the portion includes at least one building.

14. The system of claim 13 wherein the image is a street level image.

15. The system of claim 13 wherein the image is a map.

16. A system comprising:
a first computer comprising a first processor and a first memory at a first node;
a second computer comprising a first processor and a first memory at a first node, wherein the second computer communicates with the first computer over a network;
the first memory containing a program that displays images of buildings on a display in communication with the first computer and a program that transmits building identification that data identifies a building contained in the image;
the second memory containing data representing (a) whether a building occupies more than one street address, (b) the street address location of listings, (c) listing data, (d) search terms such that each building is associated with a building search term, where a building search term is selected based on the listing data of the listings associated with the street addresses occupied by the building, and (e) images of buildings;
the second memory further containing a program that identifies a search term associated with the building identified by the building identification, a program that selects information based on the search term, and a program that provides the information to the first computer via the network.

17. The system of claim 16 wherein the network comprises the Internet.

18. The system of claim 16 wherein the second computer comprises a plurality of computers and the programs stored in the second memory are stored in different computers among the plurality of computers.

19. The system of claim 16 wherein transmitting data identifying a building contained in an image comprises transmitting data identifying a portion of the image, and the second computer determines whether a building is represented at the portion of the image.

20. A method comprising:
determining, with a processor, a keyword for a single structure by iterating through a plurality of street addresses occupied by a single structure and a plurality of listings associated with the plurality of street addresses, where the keyword is selected from data associated with the listings;
identifying, with a processor, the keyword associated with a structure in response to receiving data indicating that a user has interacted with the structure;
selecting an advertisement by querying, with a processor and with the keyword identified for the structure, a plurality of advertisements where each advertisement in the set is associated with a keyword; and
displaying the advertisement to the user.

21. The method of claim 20 wherein displaying the advertisement comprises transmitting data to a remote computer for display.

22. The method of claim 20 wherein determining a keyword for a single structure further comprises determining whether the structure occupies the same street address as other structures, selecting a subset of listings from a set of listings associated with said same street address where the subset of listings are located at the same structure, and selecting the keyword based on the data associated with the subset of listings.

23. The method of claim 22 wherein determining a keyword for a single structure further comprises selecting the keyword based on listings that are located at said same address but not associated with the other structures.
